(19) United States
(12) Patent Application Publication
(10) Pub. No.: US 2025/0258284 A1
(43) Pub. Date: Aug. 14, 2025

(54) DEVICE AND METHOD FOR TESTING PROTECTIVE EQUIPMENT FOR SAFEGUARDING A PATH OF A VEHICLE, IN PARTICULAR OF AN AUTOMATED GUIDED VEHICLE

(71) Applicant: SICK AG, Waldkirch (DE)

(72) Inventor: Stephan HAGEDORN, Waldkirch (DE)

(21) Appl. No.: 19/048,859

(22) Filed: Feb. 8, 2025

(30) Foreign Application Priority Data
Feb. 9, 2024 (EP) 24156786.6

(51) Int. Cl. G01S 7/497; G01S 17/931

(52) U.S. Cl. CPC G01S 7/497; G01S 17/931

(57) ABSTRACT

The invention relates to a device for testing protective equipment of a vehicle, in particular of an automated driverless vehicle, wherein the protective equipment has at least one sensor for monitoring a path of the vehicle. The device comprises a base and a test body that is movably arranged at the base and that is movable from a first position into a second position, wherein the device is positionable in the path of the vehicle and is dimensioned such that the device is not detectable by the sensor in the path of the vehicle or no safety related action is triggered by the protective equipment on a detection of the test body when the test body is in the first position and the test body is detectable by the sensor and a safety related action is triggered by the protective equipment on a detection of the test body if the test body is in the second position.

The invention relates to a device and to a method for testing protective equipment for safeguarding a path of an automated guided vehicle.

Automated guided vehicles (AGVs) are used in industrial environments, for example in logistics. They there frequently share the same workspace or movement space as persons working or present there. These vehicles therefore have protective equipment that comprises sensors for recognizing objects and/or persons, in particular in the path of the AGV, and corresponding evaluation units. Laser scanners are frequently used for this purpose that as a rule have moving optics and devices for a time of flight measurement. An alternative to the use of laser scanners comprises the use of monitoring sensors. working in accordance with the principle of laser triangulation. As a rule the protective equipment has a monitored zone in which at least one warning field and at least one protected field can be defined. If an object and/or a person enters the protected field of the protective equipment, the latter has to trigger a safety related response that prevents a collision of the vehicle with the object or the person, for example a deceleration of the vehicle until a standstill. This protective function should be tested regularly since the braking distance of the vehicle can very over the period of use due to wear and other environmental influences and one dimension of the configured protected field is thus no longer sufficient to bring the vehicle to a stop in good time. A braking of the vehicle at full speed therefore has to be triggered on the penetration of an object and/or a person into the protected field to test the protective equipment. Since an object in the path of the vehicle is, however, as a rule first detected by the warning field of the protective equipment, this can already result in a response in the form of a speed reduction of the vehicle before the object enters into the protected field so that the test result can be falsified since deceleration is no longer from a maximum speed. It follows on from this that the triggering of the protected field has to take place without any prior triggering of the warning field. The object therefore has to be introduced into the protected field without previously being detected by the warning field.

Devices are known from the automotive sector to drive obstacles into the detection zone of, for example, adaptive speed regulation systems or pre-crash systems.

DE 10 2008 051 233 A1 shows such a device for testing a function of a driving assistance system in motor vehicles, wherein dummies of moving objects that occur in road traffic are movable reproducibly by means of a rail system in relation to the position of the moving motor vehicle. The movement of the dummies can be controlled via sensors that can determine the position of the motor vehicle.

Such test devices are as a rule arranged as stationary and cannot be used in a mobile manner due to their size, for example for testing automated forklift trucks in the industrial environment, in particular as part of an annual inspection of the protective equipment.

It is likewise known to reprogram protective equipment of AGVs for testing such that objects detected in the warning field are, for example, ignored by the protective equipment so that only objects detected by the protected field trigger a safety related action. It is disadvantageous here that the protective equipment is only tested in a reprogrammed state and not in an original state. There is additionally a risk that the protective equipment is not reset into the original state after the test.

Starting from this prior art, it is therefore the object of the invention to provide a device and a method for testing protective equipment of a vehicle, in particular of an automated guided vehicle, that can be used simply and flexibly.

This object is satisfied by a device for testing protective equipment of a vehicle and by a method of testing protective equipment of a vehicle in accordance with the respective independent claim.

The invention starts from the basic idea that protective equipment of vehicles, in particular of automated guided vehicles, are as a rule configured such that objects that do not exceed a certain size, in particular a height above a surface, for example a track or a floor of a factory facility, do not result in a triggering of a safety related action of the protective equipment. It should thereby be prevented that an unwanted triggering of the protective equipment takes place when, for example, objects close to the ground or the track itself are detected by the sensor due to a pitch of the vehicle. The protective equipment can be configured for this purpose, for example, such that a monitored zone of the protective equipment is located at a minimum height above the track or above the floor of the factory facility on which the vehicle moves along a path. Alternatively, the protective equipment can be configured to ignore detected objects having a maximum specified height, that is to not trigger a safety related action if the detected object does not exceed a specified maximum height.

A device in accordance with the invention for testing protective equipment of a vehicle that has at least one sensor for monitoring a path of the vehicle comprises a base and a test body movably arranged on the base for this purpose. The test body can be moved from a first position into a second position, for example by pivoting or displacing with respect to the base by mechanical, electromechanical, pneumatic, or hydraulic arrangements customary in the art. The path of the vehicle is here in particular to be understood as the zone, for example a track or a production area that is traversed by the vehicle as a result of its movement.

The device can be positioned in the path and is dimensioned such that the device in the path of the vehicle is not detectable by the sensor of the protective equipment or a detection of the device in the path does not trigger a safety related action of the protective equipment if the test body is in the first position and the test body is detected by the sensor of the protective equipment and a safety related action of the protective equipment is triggered when the test body is in the second position. If the test body is in the first position, the device can preferably be dimensioned such that a height of the device is smaller than a minimum height of a monitored zone of the protective equipment above a track on which the vehicle moves.

The invention has the advantage that the device for testing the protective equipment of the vehicle can be positioned in the path of the vehicle without a safety related action of the protective equipment being triggered. The device is thus particularly flexibly usable in comparison with the stationary devices known from the prior art and can in particular be used for testing the protective equipment at the site of use. A reprogramming of the protective equipment for testing the same is likewise not required.

The device is preferably dimensioned such that its maximum height does not exceed 200 mm, particularly preferably not 150 mm, very particularly preferably not 100 mm, when the test body is in the first position. It can thus be ensured that the device for testing typical protective equipment is suitable for automated guided vehicles, in particular in accordance with the standards IEC 62046 or ISO 3691-4.

The device preferably has a weight of less than 10 kg. The device particularly preferably has a weight of less than 5 kg. The device can thereby be very easily positioned by a person in the path of the vehicle.

The device can preferably have its own power source and can thus be indirectly supplied with electrical power independently of stationary power sources. The device can particularly preferably have a mount for an external power source, for example a so-called power bank.

The test body can be displaceable between the first position and the second position. The base of the device can here have a mount for the test body in which the test body can be displaceably supported. The displacement can preferably take place by a spring element.

In an alternative embodiment, the test body can be pivotable between the first position and the second position. The base of the device can here have a mount for the test body in which the test body is rotatably supported. A device with a particularly small height can be implemented by this embodiment.

The test body can preferably be a cylindrical body. The diameter of the test body preferably amounts to 70 mm. A recognition of a human leg by the protective equipment can thus be tested in line with the standard, for example.

The test body preferably comprises a flexible material. Damage to the vehicle can thereby be prevented or at least reduced if the vehicle collides with the test body. Alternatively or additionally, the base of the device can preferably have slide feet and/or rollers whereby the device can be displaced over the track if the vehicle collides with the device or the test body. Damage to the vehicle can thereby be further prevented or reduced.

The device can preferably have a distance sensor to determine a distance between the device and the vehicle. A control and evaluation unit is particularly preferably configured to move the test body from the first position into the second position in dependence on the distance between the device and the vehicle. The control and evaluation unit an in particular be configured to continuously determine the distance between the device and the vehicle.

The control and evaluation unit can preferably be configured to receive dimensions of a warning field and/or of a protected field of the protective equipment and to move the test body from the first position into the second position in dependence on the dimension of the warning field or of the protected field when, for example, the distance between the vehicle and the device is smaller than the extent of the warning field or of the protected field in the direction of travel of the vehicle.

The control and evaluation unit can preferably be configured to determine a speed of the vehicle and to record a time progress of the speed and/or of the distance between the device and the vehicle The braking distance and/or braking acceleration of the vehicle can thereby be determined, for example.

The control and evaluation unit can preferably have a database for storing test results specific to the vehicle or an interface to transmit test results specific to the vehicle. Test results can thus, for example, be detected and/or evaluated in a manner specific to the vehicle in a regular vehicle test.

The control and evaluation unit can have one or more digital processing modules, for example a microprocessor, an FPGA, or an ASIC, and can be part of the device or can be provided externally at least in part.

The method in accordance with the invention can be further developed in a similar manner and shows similar advantages in so doing. Such advantageous features are described in an exemplary, but not exclusive manner in the subordinate claims dependent on the independent claims.

The invention will be explained in detail in the following with reference to embodiments and to the drawing. There are shown in the drawing:

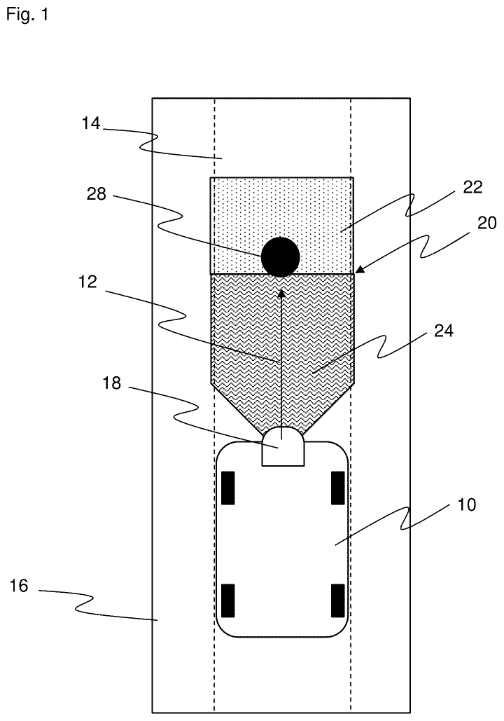

FIG. 1 a schematic plan view of a vehicle;

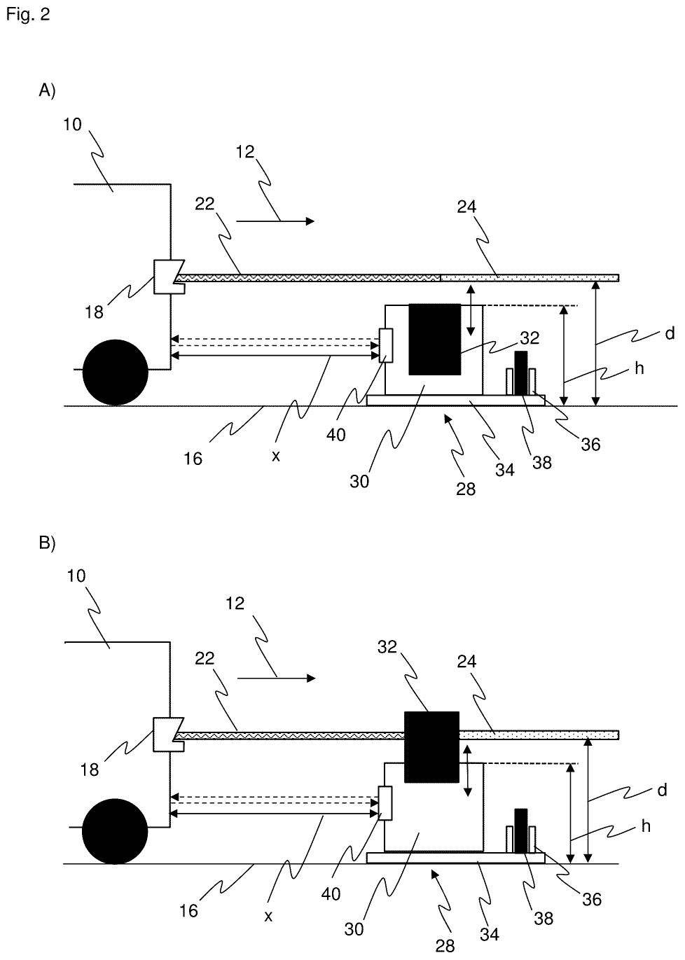

FIG. 2 a schematic side view of a device in accordance with the invention for testing protective equipment of a vehicle; and

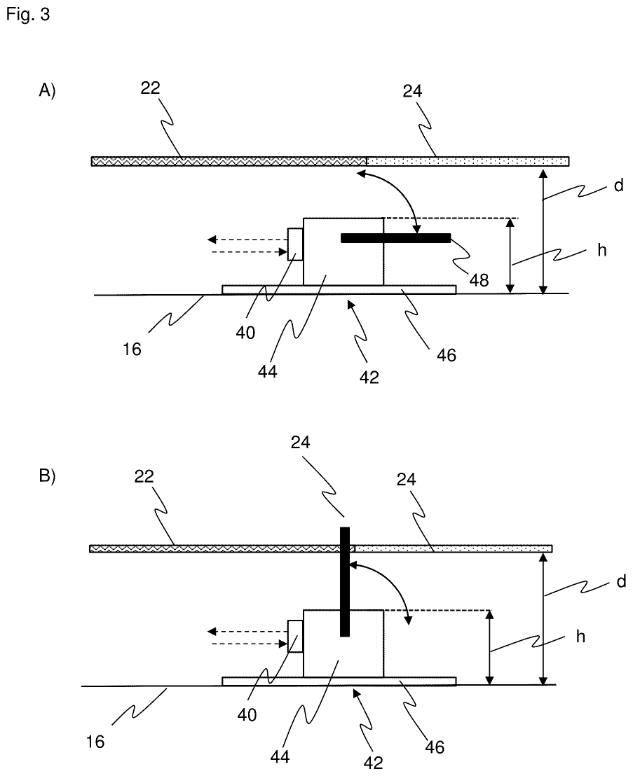

FIG. 3 a schematic side view of an alternative embodiment of a device in accordance with the invention for testing protective equipment of a vehicle.

FIG. 1 shows a schematic plan view of a vehicle 10, for example of an automated guided vehicle, that moves along a direction of travel 12 on a path 14 on a track 16. A sensor 18 of protective equipment (not shown) fastened to the vehicle 10, for example a laser scanner, scans a monitored zone 20 having a warning field 22 and a protected field 24. The monitored zone 20 in particular covers a part of the path 14 in the direction of travel 12 so that an object 26 in the monitored zone 20 located in the path 14 of the vehicle 10 is detected by the sensor 18 of the protective equipment. If the object 26 enters into the warning field 22, a warning can first be output or a deceleration of the vehicle 10 can be initiated by the protective equipment. When the object 26 enters into the protected field 242, a safety related action is typically triggered by the protective equipment, for example a deceleration of the vehicle 10 to a standstill.

FIG. 2 shows a schematic side view of a device 28 in accordance with the invention for testing the protective equipment of the vehicle 10. The monitored zone 20 scanned by the sensor 18 of the protective equipment is at a distance d above the track 16. The device 28 is positioned in the path 14 of the vehicle 10 and comprises a base 30 and a test body 32 that is movably arranged at the base 30 and that is movable from a first position into a second position by displacement. The base 30 of the device 28 is arranged on a base plate 32 with a mount 36 for a power bank 38 by which the device 28 can be supplied with electrical power independently of stationary power sources.

In A), the test body 32 of the device 28 is at the first position and has traveled into the base 30. The device 28 is thus dimensioned such that it cannot be detected by the sensor 18 of the vehicle 10 even though it is in the path 14 of the vehicle 10. The height h of the device 28 is in particular smaller than the minimum height Hₘᵢₙ of the monitored zone 20 above the track 16. No action of the protective equipment is thus triggered, in particular no deceleration of the vehicle 10.

In B), the test body 32 of the device 28 is at the second position and has traveled out of the base 30. The test body 32 thus projects into the protected field 24 of the monitored zone 20 of the sensor 18 in the embodiment. The test body 32 can therefore be detected by the sensor 18 and the protective equipment can trigger a safety related action without a prior influencing of the vehicle 10, for example a deceleration, having taken place.

The device furthermore has a distance sensor 40 for determining a distance x between the vehicle 10 and the device 28. A control and evaluation unit (not shown) is configured to control the device 28 such that the test body 32 is moved from the first into the second position in dependence on the distance x of the device 28 from the vehicle 10, for example when the distance x between the vehicle 10 and the device 28 falls below a specified value, in particular when the distance x is smaller than the extent of the protected field 24 in the direction of travel 12 of the vehicle 10. The control and evaluation unit can be configured for this purpose to receive dimensions of the warning field 22 and/or of the protected field 24.

FIG. 2 shows a schematic side view of an alternative embodiment of a device 42 in accordance with the invention for testing protective equipment of a vehicle 10, with only the device 42 itself as well as the warning field 22 and the protected field 24 of the protective equipment being shown. Corresponding to the embodiment shown in FIG. 1, the device 42 has a base 44 having a base plate 46 and a distance sensor 40. Unlike the embodiment shown in FIG. 1, the test body 48 is arranged pivotably or foldably at the base 44.

In A), the test body 48 is pivoted downward in the direction of the base plate 46 in a first position so that it does not project into the warning field 22 or the protected field 24 of the protective equipment. The device 42 is therefore not detected by the sensor of the protective equipment.

In B) the test body 48 is pivoted upward in a second position so that it projects into the protected field 24 of the protective equipment. The test body 48 is therefore detected by the sensor 18 of the protective equipment so that a safety related action can be triggered by the protective equipment without a prior influencing of the vehicle 10, for example a deceleration, having taken place.

### REFERENCE NUMERAL LIST

10 vehicle
12 direction of travel
14 path
16 track
18 sensor
20 monitored zone
22 warning field
24 protected field
26 object
28, 42 device
30, 44 base
32, 48 test body
34, 46 base plate
36 mount
38 external voltage source (power bank)
40 distance sensor
Hₘᵢₙ minimum height
h height
x distance

1. A device for testing protective equipment of a vehicle, wherein the protective equipment has at least one sensor for monitoring a path of the vehicle and the device comprises a base and a test body movably arranged at the base, wherein the test body is movable from a first position into a second position, and wherein the device can be positioned in the path of the vehicle and is dimensioned such that the device in the path of the vehicle is not detectable by the sensor or no safety related action of the protective equipment is triggered on a detection of the test body when the test body is in the first position and the test body is detectable by the sensor and a safety related action of the protective equipment is triggered on the detection of the test body when the test body is in the second position.

2. The device in accordance with claim 1, wherein the vehicle is an automated guided vehicle.

3. The device in accordance with claim 1, wherein the test body is displaceable between the first position and the second position.

4. The device in accordance with claim 1, wherein the test body is pivotable between the first position and the second position.

5. The device in accordance with claim 1, wherein the device has a mount for an external power source.

6. The device in accordance with claim 1, wherein the device has a distance sensor for determining a distance between the device and the vehicle.

7. The device in accordance with claim 6, wherein a control and evaluation unit is configured to control the device such that the test body is moved from the first position into the second position in dependence on the distance between the device and the vehicle.

8. The device in accordance with claim 7, wherein the test body is moved from the first position into the second position when falling below a specified distance between the device and the vehicle.

9. The device in accordance with claim 8, wherein the specified distance is smaller than an extent of a protected field of the protective equipment in a direction of travel of the vehicle.

10. The device in accordance with claim 6, wherein a control and evaluation unit is configured to determine a speed of the vehicle.

11. The device in accordance with claim 10, wherein the control and evaluation unit is configured to record a time progression of the speed and of the distance of the device from the vehicle.

12. A method of testing protective equipment of a vehicle, said method comprising the steps:
positioning a device in accordance with claim 1 in a path of the vehicle;
moving the test body from the first position into the second position such that the test body is detectable by a sensor of protective equipment of the vehicle and a detection of the test body by the sensor triggers a safety related action of the protective equipment.

13. The method in accordance with claim 12, comprising the further steps
determining a distance between the device and the vehicle;
moving the test body from the first position into the second position when the distance falls below a specified value.

14. The method in in accordance with claim 12, wherein the specified distance is an extent of a protected field of the protective equipment in a direction of travel of the vehicle.

15. The method in accordance with claim 13 comprising the further steps
continuous determination of the distance between the device and the vehicle
recording a time progression of the distance between the device and the vehicle.

16. The method in accordance with claim 14 comprising the further steps
continuous determination of the distance between the device and the vehicle
recording a time progression of the distance between the device and the vehicle.

17. The method in accordance with claim 12, wherein the vehicle is an automated guided vehicle.
